(19) United States
(12) Patent Application Publication
(10) Pub. No.: US 2016/0300569 A1
(43) Pub. Date: Oct. 13, 2016

(54) SPEECH CONTROLLED SEX TOY

(71) Applicant: AIPleasures, Inc., Santa Clara, CA (US)

(72) Inventors: Yan Zhou, Santa Clara, CA (US); Jianbo Shi, Philadelphia, PA (US); Liming Wang, Hayward, CA (US); Lei Tan, El Cerrito, CA (US)

(21) Appl. No.: 14/846,735

(22) Filed: Sep. 5, 2015

Related U.S. Application Data
(60) Provisional application No. 62/146,838, filed on Apr. 13, 2015.

(51) Int. Cl. G10L 15/22; G10L 15/197; A61H 19/00; G05B 19/04

(52) U.S. Cl. CPC G10L 15/22; G05B 19/041; G10L 15/197; A61H 19/00; G10L 2015/223; A61H 2201/5007; A61H 2201/5048

(57) ABSTRACT

A speech controlled sex toy receives verbal commands through audio receiving device paired with the toy, converted the speech to control signals to adjust the operation or intensity of motor within the sex toy. The sex toy has a speech recognition module to convert human voice to machine understandable control signals, and a microprocessor control module to communicate control signals to adjust the motion of motor. If necessary, temperature of the sex toy can be measured and adjusted according to verbal commands. The sex toy receives human voice from the user or user's partner.

### CROSS REFERENCE TO RELATED APPLICATIONS

This application claims priority to U.S. Provisional Patent Application No. 62/146,838 filed Apr. 13, 2015, the contents of which are incorporated by reference herein in its entirety.

### TECHNICAL FIELD

This invention relates generally to the field of sex toys, and particularly sex toys that are controlled by human voice commands, in which stimulation provided to users is correlated to the commands.

### BACKGROUND

The sex toy industry is one of the large aspects of adult entertainment today. These devices can be used to contact users'skin and sensitive body parts, or dispose internally (e.g., kegel exercise devices) to massage body parts for sexual stimulation. Sex toys are typically equipped with control buttons/panels that would allow users to adjust the operation of motors and thereby alter users'sensations. However, most sex toys use push buttons to control the operation of their motors. Some sex toys use a remote control or wireless connection to remotely control the toy through computer network. However, it still requires users to press buttons on remote controls or user end programs (e.g., cell phone apps). Therefore controllers of such type are not convenient as they need to be operated by hands, which could be very tiring and distract users from enjoying sexual stimulation.

There are needs in the sex toy field in which operation of the device can be controlled by voice commands, so that users can control the toy in a hands-free manner. Against the foregoing background, the current invention was developed.

### SUMMARY

A speech controlled sex toy receives verbal commands through audio receiving device paired with the toy, converted the speech to control signals to adjust the operation or intensity of motor within the sex toy. The sex toy has a speech recognition module to convert human voice to machine understandable control signals, and a microprocessor control module to communicate control signals to adjust the motion of motor. If necessary, temperature of the sex toy can be measured and adjusted according to verbal commands. The sex toy receives human voice from the user or user's partner.

The preceding summary and the following detailed description are exemplary only and do not limit the scope of the claims.

### BRIEF DESCRIPTION OF THE DRAWINGS

The accompanying drawings, which are incorporated in and constitute a part of this specification, in connection with the description, illustrate various embodiments and exemplary aspects of the disclosed embodiments. In the drawings:

FIG. 1 is a side view of an example speech controlled sex toy device 1, in accordance with one novel aspect;

FIG. 2 is an exemplary circuit diagram showing the process of using control signals to change motion of the motor 2;

FIG. 3 is an exemplary circuit diagram showing the process of using control signals to change temperature of the device 1;

FIG. 4 is a flow chart showing interactive operations between device 1 and the user or the user's partner;

FIG. 5 shows a diagram representation of speech recognition module which contains front-end unit, model unit, language model unit, and search unit.

### DESCRIPTION OF EXEMPLARY EMBODIMENTS

Reference will now be made in detail to exemplary embodiments, examples of which are illustrated in the accompanying drawings. When appropriate, the same reference numbers are used throughout the drawings to refer to the same or like parts.

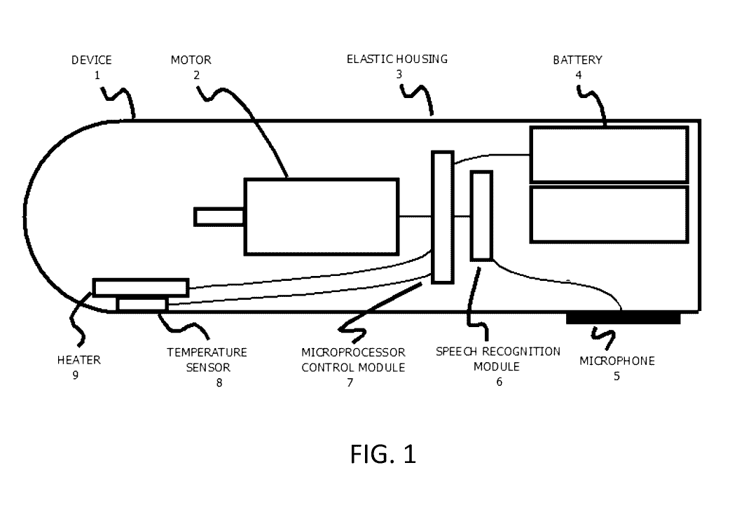

FIG. 1 is a side view of an example speech controlled sex toy device 1, in accordance with one novel aspect. The device 1 has an elastic housing 3 made from flexible material such as silicone or cyberskin. Typical devices comprises of female masturbation devices, kegel exercise devices, male masturbation devices, massagers, paired masturbation devices for couples.

Human voice forms verbal commands represented by single words comprising of: “faster”, “harder”, “slower”, “start”, “stop”, “hotter”, “cooler”; or phrases comprising of: “move faster”, “move slower”, “power on”, “power off”, “get hotter”, “get cooler”; or sentences of similar kind All verbal commands can be in different languages. They can be stored in the device, customized or programmed by users. Languages comprise of: English, Spanish, Chinese, Hindi, German, French, Arabic, Russian, Japanese, Portuguese, Bengali, Korean, Italian.

Human voice is transmitted to the device. The transmission is done through media comprising of: air, and computer network that includes internet, Bluetooth connection, Wi-Fi connection. The sender of the said human voice can be from the user, the user's partner, or other audio input comprising of videos, CD, computer, tablets, and phones. In the current example, human voice is transmitted through air to the microphone 5 attached to the device.

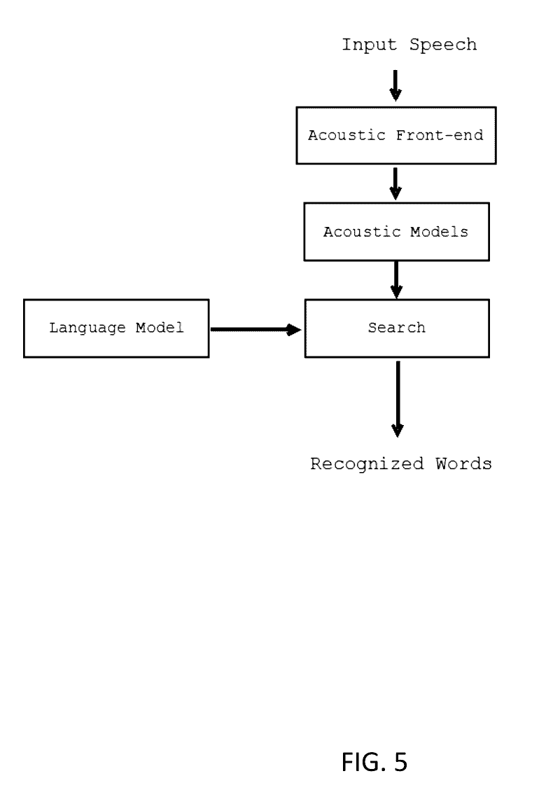

Once the audio signal is received, a speech recognition module 6 identifies the meaning of the received speech, and convert it to control signals to control the motor 2. Speech recognition is the process of converting a speech signal to a sequence of words, by means of an algorithm implemented as a computer program. Speech recognition technology has made it possible for computer to follow human voice commands and understand human languages. The speech recognition module can also understand semantic content of the said speech. FIG. 5 shows a diagram representation of speech recognition module which contains front-end unit, model unit, language model unit, and search unit. Note that the control signals can also be transmitted from computer network comprising of internet, Bluetooth connection, Wi-Fi connection. For example, a user can talk on the phone and use the verbal commands to control the partner's device remotely.

Motor 2 is positioned within housing. The motor is a type taken from a group comprising of a vibration motor, a stepper, an actuator and a solenoid. Most of the sex toys on the market use vibration motors. Their sizes are relatively small, easy to position and can have various vibration mode. However, the vibration motion is very different from human natural movement. Therefore, in the current example, a solenoid is employed to produce vertical thrusting movement like human penetration.

Note that the said motor can be used together with one or more motors to provide various operations or intensity. At least one said motor is controlled by the control signals from the speech recognition module. The said various operations or intensity of the motor comprises of: adjusting the motion of the motor, adjusting the temperature of the device, adjusting the programmable settings of the device.

In particular, adjusting the motion of the motor means producing effects comprising of: power on and off, vibrating intensity alternation, vibrating mode alternation, thrusting (vertical motion) speed alternation, thrusting (vertical motion) intensity alternation, activating the device at a particular time, changing of shape of the said housing. In the current example, a user can specify the thrusting frequency range from 0.5 times per second to 50 times per second to adjust the speed.

Adjusting the temperature of the device means heating the device up or cooling the device down to a certain temperature. That involves a heating device 9 for heating and cooling, and a temperature sensor 8 to measure the temperature. Those two devices are connected to the microprocessor control module 7 to coordinate with each other. Note that the device can use multiple sensors comprising of: a temperature sensor, a touch sensor, a pressure sensor, an accelerometer, a stretch sensor, a bend sensor and a galvanic sensor.

What is more, the programmable settings of the device can be modified, and pre-stored for the purpose of providing customized sequences of motion of said motor. For example, a user can program a setting of nine times of higher frequency penetration (thrusting) followed by one time of lower frequency penetration. A user can also choose the settings pre-stored in the device, for example a “surprise me” setting that randomly change the penetration speed of the device. The said programmable settings can be shared through internet. Users can upload their own settings for sharing, and download settings to the device from the internet.

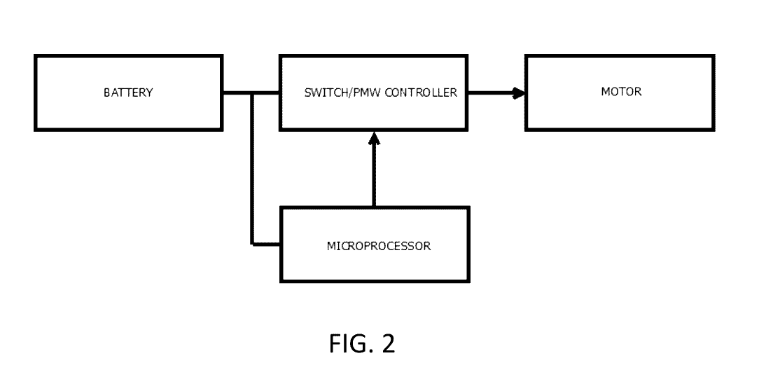

FIG. 2 is an exemplary circuit diagram showing the process of using control signals to change motion of motor 2. The control signals can be in the form of voltage variation with time, alternating on and off of a control button, or pulse width modulation (PWM). Once the microprocessor 7 receives recognized verbal commands through speech recognition module 6, it communicates it to motor 2 in several ways comprising of: 1) switching power of motor 2 “on-off” at different frequencies to change the speed of motor. Usually higher frequency means faster speed, lower frequency means lower speed; 2) Regulating the amount of voltage across its terminals and this can be achieved using “Pulse Width Modulation” or PWM. As its name suggests, pulse width modulation speed control works by driving the motor with a series of “on-off” pulses and varying the duty cycle, the fraction of time that the output voltage is “on” compared to when it is “off”, of the pulses while keeping the frequency constant. The power applied to the motor can be controlled by varying the width of these applied pulses and thereby varying the average DC voltage applied to the motors terminals. By changing or modulating the timing of these pulses the speed of the motor can be controlled, i.e., the longer the pulse is “on”, the faster the motor, likewise, the shorter the pulse is “on” the slower the motor is. Motor intensity can be adjusted in a similar way.

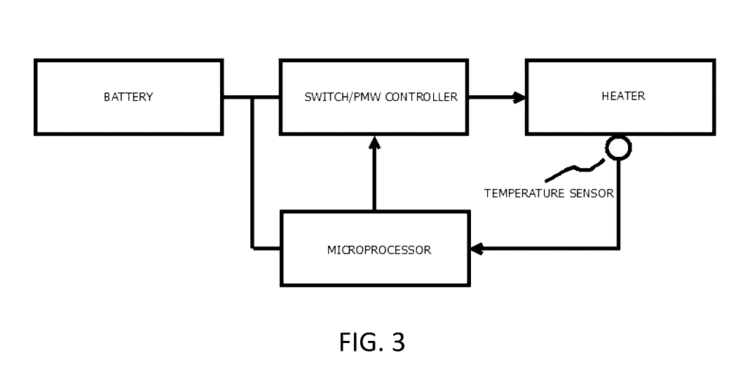

FIG. 3 is an exemplary circuit diagram showing the process of using control signals to change temperature of device 1. Instead of controlling motion of motor in FIG. 2, once the microprocessor 7 receives recognized verbal commands through speech recognition module 6, it communicates it to heater 9 to heat or cool the device. The temperature sensor 8 which is located next to heater 9 measures the current temperature in real-time, and sends it back to the microprocessor 7 in order to adjust the heater 9 to reach required temperature. For example, the adjustable temperature of the device can be in the range of 4 to 50 degree Celcius to cover human pain receptors active range.

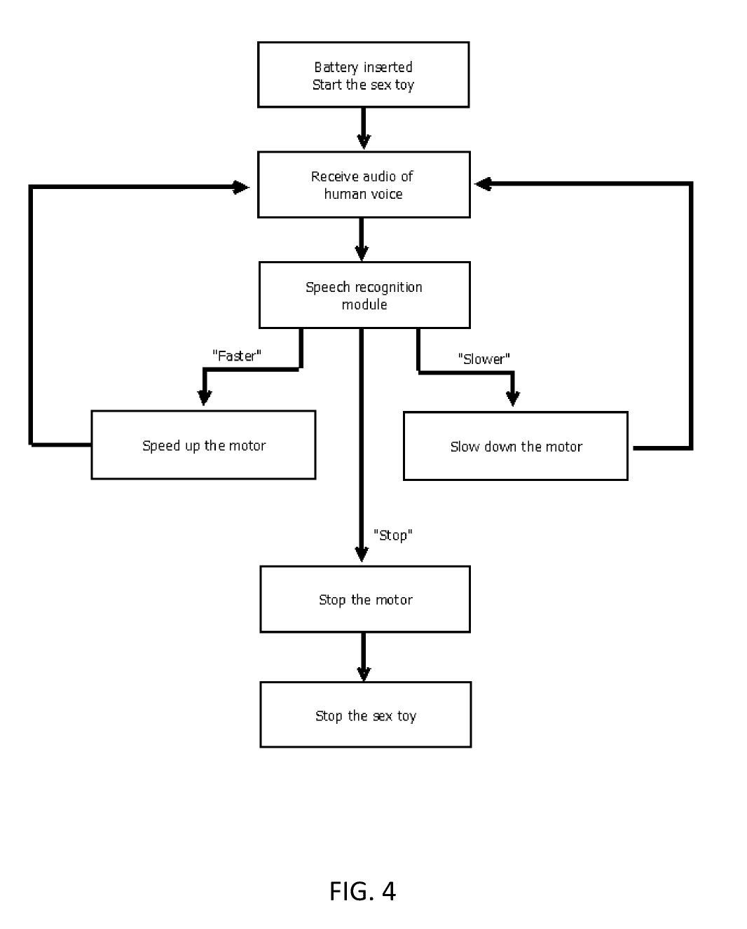

FIG. 4 is a flow chart showing interactive operations between device 1 and the user or the user's partner. Note that verbal commands from the user or user's partner can be single words for example: “faster”, “slower”, “harder”, “start”, “stop”, “hotter”, “cooler”, or phrases for example: “move faster”, “move slower”, “get hotter”, “get cooler”, or sentences. All words, phrases and sentences can be customized and programmed.

FIG. 5 shows a diagram representation of speech recognition module which contains front-end unit, model unit, language model unit, and search unit. The standard approach to speech recognition is to assume a probabilistic model of speech production whereby a specified word sequence produces an acoustic observation sequence with probability. The goal is to decode the word string based on the acoustic observation sequence, so that the decoded string has the maximum a posteriori (MAP) probability. Acoustic model estimates the probability of a sequence of acoustic observations conditioned on the word string. Language model describes the probability associated with a postulated sequence of words. Such language models can incorporate both syntactic and semantic constraints of the language and the recognition task.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

1. An apparatus comprising:
a housing
a speech recognition module that produces control signals; and
a motor, wherein the motion of said motor varies in response to said control signals, wherein said apparatus is adjusted such that said speech recognition Module produces said control signals in response to human voice.

2. The apparatus of claim 1, wherein said apparatus is a sex toy of a type taken from the group comprising of: female masturbation devices, kegel exercise devices, male masturbation devices, massagers, paired masturbation devices for couples.

3. The apparatus of claim 1, wherein said housing composes of an elastic material.

4. The apparatus of claim 1, wherein said human voice forms verbal commands represented by single words comprising of: “faster”, “harder”, “slower”, “start”, “stop”, “hotter”, “cooler”; or phrases comprising of: “move faster”, “move lower”, “power on”, “power off”, “get hotter”, “get cooler”; or sentences of similar kind. All verbal commands can be in different languages. They can be stored in the device, customized or programmed by users.

5. The apparatus of claim 1, wherein said speech recognition module recognizes said speech of a language taken from the group comprising of: English, Spanish, Chinese, Hindi, German, French, Arabic, Russian, Japanese, Portuguese, Bengali, Korean, Italian.

6. The apparatus of claim 5, wherein said recognized speech is converted to control signals to change operation or intensity of the motor that comprises of: adjusting the motion of said motor, adjusting the temperature of said sex toy, adjusting the programmable settings of the sex toy. The control signals can be in the form of voltage variation with time, alternating on and off of a control button, or pulse width modulation (PWM).

7. The apparatus of claim 6, wherein said control signals can also be transmitted from computer network comprising of Internet, Bluetooth connection, Wi-Fi connection.

8. The apparatus of claim 6, wherein said programmable settings can be modified, and pre-stored in the sex toy for the purpose of providing customized sequences of emotion of said motor. The said programmable settings can be shared through internet.

9. The apparatus of claim 1, wherein the motion of said motor is varied to produce effects comprising of: power on and off, vibrating intensity alternation, vibrating mode alternation, thrusting (vertical motion) speed alternation, thrusting (vertical motion) intensity alternation, activating the, device at a particular time, changing of shape of the said housing.

10. The apparatus of claim 1, wherein the said motor is positioned within housing. The motor is a type taken from a group comprising of a vibration motor, a stepper, an actuator and a solenoid. The said motor can be used together with one or more motors to provide various motions defined in claim 9. At least one said motor is controlled by the control signals from said speech recognition module.

11. The apparatus of claim 1, also composes of a microprocessor that receives control signals from the speech recognition module, processes the signals and communicates the control signals to said motor.

12. A method comprising:
receiving human voice;
producing a control signal in response to receiving said voice; and
adjusting the motion of a motor in response to said control signal.

13. The method of claim 12, wherein human voice is transmitted to the device. The transmission is done through media comprising of: air, and computer network that includes internet, Bluetooth connection, Wi-Fi connection. The sender of the said human voice can be from the user, the user's partner, or other audio comprising of videos, CD, computer, tablets, and phones.

14. The method of claim 12, wherein said control signal is generated by a speech recognition module that identifies the meaning of the speech from the sender, and convert it to a said control signal accordingly.

15. The apparatus of claim 14, wherein said speech recognition module can also understand semantic content of the said speech.

16. The method of claim 12, wherein said method is performed in response to using a sex toy.

17. A sex toy comprising:
a housing;
a motor; and
methods for controlling said motor in response to verbal commands in course of using said sex toy.

18. The sex toy of claim 17 can be voice activated to provide “on demand” capability.

19. The sex toy of claim 17 can have “alarm” settings wherein the sex toy is self-activated at a preset time by the user.

20. The sex toy of claim 17 includes a motor selected from a group comprising of: a vibration motor, a stepper, an actuator, and a solenoid; it can also use multiple sensors comprising of: a temperature sensor, a touch sensor, a pressure sensor, an accelerometer, a stretch sensor, a bend sensor and a galvanic sensor.
